(19) United States
(12) Patent Application Publication
(10) Pub. No.: US 2017/0344669 A1
(43) Pub. Date: Nov. 30, 2017

(54) METHOD FOR VERIFYING ERROR OF DIGITAL CIRCUIT

(71) Applicant: SAMSUNG SDS CO., LTD., Seoul (KR)

(72) Inventors: Min Woo JEONG, Seoul (KR); Tae Hwan JEONG, Seoul (KR); Hyun Jung SOH, Seoul (KR); Hye Ran LEE, Seoul (KR)

(73) Assignee: SAMSUNG SDS CO., LTD., Seoul (KR)

(21) Appl. No.: 15/586,416

(22) Filed: May 4, 2017

(30) Foreign Application Priority Data
May 26, 2016 (KR) 10-2016-0065004

(51) Int. Cl. G06F 17/50; G06N 7/00; G06N 99/00

(52) U.S. Cl. CPC G06F 17/504; G06N 99/005; G06F 17/5081; G06N 7/005

(57) ABSTRACT

Methods for verifying error in digital circuit are provided, one of methods comprises, generating a first attribute value using metadata of a first digital circuit diagram, mechanically decomposing a digital circuit indicated by the first digital circuit diagram into individual elements, generating a second attribute value using the result of mechanical decomposition, and generating an attribute database comprising the first attribute value and the second attribute value by using an apparatus for verifying an error in a digital circuit, performing supervised learning using the attribute database to generate a pattern according to a verification purpose and generating a pattern database comprising the generated pattern by using the digital circuit error verification apparatus and generating a third attribute value and a fourth attribute value by analyzing a second digital circuit diagram, which is a target of error verification, in the same way as the first digital circuit diagram, generating verification request data comprising the third attribute value and the fourth attribute value, selecting a comparison target pattern from the pattern database according to a verification purpose, and verifying an error in the second digital circuit diagram by comparing the selected comparison target pattern and the verification request data by using the digital circuit error verification apparatus.

This application claims the benefit of Korean Patent Application No. 10-2016-0065004, filed on May 26, 2016, in the Korean Intellectual Property Office, the disclosure of which is incorporated herein by reference in its entirety.

### BACKGROUND

### 1. Field

The current inventive concept relates to a method of verifying an error in a digital circuit, and more particularly, to a method of detecting an error in a more reliable manner by accumulating a large amount of data in a database as error detection is repeatedly performed through machine learning on error detection of digital circuits.

### 2. Description of the Related Art

Digital circuits are essential for various electronic components, and design changes are not easy after production. Therefore, it is very important to check whether an error occurs in the operation of a designed digital circuit before the digital circuit is actually produced, and this can be performed by a digital circuit design inspection system.

A conventional digital circuit design inspection system creates a template from data that is supposed to operate normally based on a previously completed digital circuit diagram or the result of simulating the digital circuit diagram and judges an error in design by comparing the created template with a digital circuit to be inspected. However, this method has the problem that when a new digital circuit is verified, the reliability of the verification result is very low unless a pre-created template identical to the new digital circuit is present. In addition, since the simulation result is the result of a test performed in a very ideal environment, it is not possible to accurately predict an error that may occur in the process of actually producing a digital circuit.

In this regard, there is a need for a new and advanced digital circuit design inspection system which can improve the reliability of the verification result of a digital circuit even in the absence of a pre-created template and accurately predict an error that may occur in the actual production process.

### SUMMARY

Aspects of the inventive concept provide a method of verifying an error in a digital circuit in a more reliable manner even in the absence of a pre-created template.

Aspects of the inventive concept also provide a method of verifying an error in a digital circuit by accurately predicting an error that may occur in an actual production process.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

In some embodiments, a method for verifying error in digital circuit, the method comprises, generating a first attribute value using metadata of a first digital circuit diagram, mechanically decomposing a digital circuit indicated by the first digital circuit diagram into individual elements, generating a second attribute value using the result of mechanical decomposition, and generating an attribute database comprising the first attribute value and the second attribute value by using an apparatus for verifying an error in a digital circuit, performing supervised learning using the attribute database to generate a pattern according to a verification purpose and generating a pattern database comprising the generated pattern by using the digital circuit error verification apparatus and generating a third attribute value and a fourth attribute value by analyzing a second digital circuit diagram, which is a target of error verification, in the same way as the first digital circuit diagram, generating verification request data comprising the third attribute value and the fourth attribute value, selecting a comparison target pattern from the pattern database according to a verification purpose, and verifying an error in the second digital circuit diagram by comparing the selected comparison target pattern and the verification request data by using the digital circuit error verification apparatus.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the configuration of an apparatus for verifying an error in a digital circuit according to an embodiment;

FIG. 2 is a flowchart illustrating a method of verifying an error in a digital circuit according to an embodiment;

FIG. 3 is a flowchart illustrating a method of verifying an error in a digital circuit according to an embodiment, more specifically, operation S210;

FIG. 4 illustrates an example first digital circuit;

FIG. 5 is a flowchart illustrating a method of mechanically decomposing a first digital circuit into individual elements;

FIG. 6 illustrates an attribute database including a first attribute value and a second attribute value;

FIG. 7 is a flowchart illustrating a method of verifying an error in a digital circuit according to an embodiment, more specifically, operation S230;

FIG. 8 illustrates a multidimensional graph output from a pattern database;

FIG. 9 illustrates a normal section of a multidimensional graph;

FIG. 10 illustrates a moderate section of a multidimensional graph;

FIG. 11 illustrates an abnormal section of a multidimensional graph;

FIG. 12 illustrates the result of error verification displayed in a multidimensional graph; and

FIG. 13 illustrates shortest perpendicular lines extending from the result of error verification displayed in a moderate section of a multidimensional graph to a normal section and an abnormal section.

### DETAILED DESCRIPTION

All terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Hereinafter, the present invention will be described in detail with reference to the accompanying drawings.

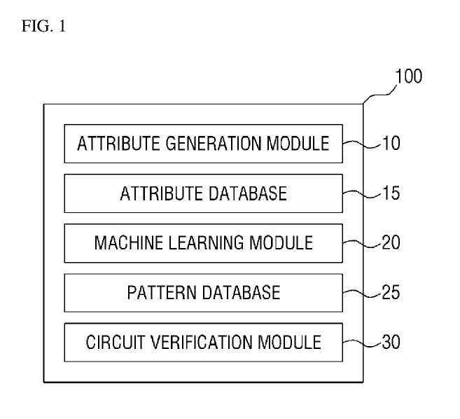

The configuration and operation of an apparatus 100 for verifying an error in a digital circuit according to an embodiment will now be described with reference to FIG. 1. Referring to FIG. 1, the apparatus 100 for verifying an error in a digital circuit according to the current embodiment may include an attribute generation module 10, a machine learning module 20 and a circuit verification module 30 and may further include an attribute database 15 and a pattern database 25. However, this is merely an example, and some components can be added or deleted as needed.

The attribute generation module 10 generates a first attribute value using metadata of a first digital circuit diagram, mechanically decomposes a digital circuit indicated by the first digital circuit diagram into individual elements, and generates a second attribute value using the result of mechanical decomposition.

In addition, the attribute generation module 10 generates the attribute database 15 including the generated first attribute value and second attribute value.

Here, the first digital circuit diagram is a design drawing of a digital circuit that can first store the first attribute value and the second attribute value in a state where no data is stored in the digital circuit error verification apparatus 100. The first attribute value and the second attribute value are data stored in the attribute database 15 and used to verify an error in a second digital circuit diagram by the circuit verification module 30.

As illustrated in FIG. 1, the attribute database 15 may be configured in the form of a large memory in the digital circuit error verification apparatus 100. However, since the first attribute value and the second attribute value are gradually accumulated as error verification of digital circuits is repeatedly performed, the attribute database 15 can also be configured as a separate server. In this case, the digital circuit error verification apparatus 100 may include a communication medium such as a communication module capable of communicating with the attribute database 15.

The machine learning module 20 performs supervised learning using the attribute database 15 to generate a pattern according to a verification purpose. Here, the supervised learning is one method of machine learning and is a kind of algorithm that can make a judgment based on data accumulated continuously.

The machine learning module 20 may generate a pattern according to a verification purpose by performing machine learning. Here, the verification purpose may be a result value that a user wants to know through verification, such as a product group of a digital circuit, a simulation result, or a defect rate at the production stage. Therefore, a pattern about a digital circuit product group, a pass/fail pattern based on a simulation result, or a pattern based on a defect rate at the production stage may be generated. However, the verification purposes and patterns described above are merely an embodiment, and more various patterns can be generated as long as they are about result values that the user wants to know through verification. As more various patterns are generated, the reliability of verification results will be enhanced.

The machine learning module 20 also generates the pattern database 25 including generated patterns.

Like the attribute database 15, the pattern database 25 may be configured in the form of a large memory in the digital circuit error verification apparatus 100 as illustrated in FIG. 1. However, since different patterns are generated according different verification purposes of different users, the pattern database 25 can also be configured as a separate server. In this case, the digital circuit error verification apparatus 100 may include a communication medium such as a communication module capable of communicating with the pattern database 15.

The circuit verification module 30 generates verification request data including a third attribute and a fourth attribute generated by analyzing the second digital circuit diagram which is a target of error verification.

Here, the second digital circuit diagram is a design drawing including a digital circuit that is to be error-verified by the digital circuit error verification apparatus 100. Since the second digital circuit diagram is analyzed by the attribute generation module 10, the verification request data is in the same format as the first attribute value and the second attribute value.

In addition, the circuit verification module 30 selects a comparison target pattern from the pattern database 25 according to a verification purpose and verifies an error in the second digital circuit diagram by comparing the selected comparison target pattern with the verification request data.

Here, the comparison target pattern may be one or more of a pattern about a digital circuit product group, a pass/fail pattern based on a simulation result, a pattern based on a defect rate at the production stage, and a pattern generated according to a result value that a user wants to know through verification. An error in the second digital circuit diagram can be verified by comparing the selected comparison target pattern with the verification request data.

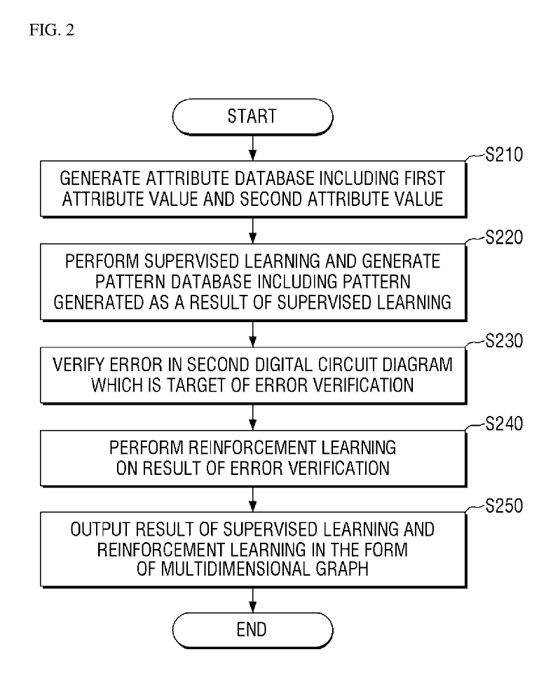

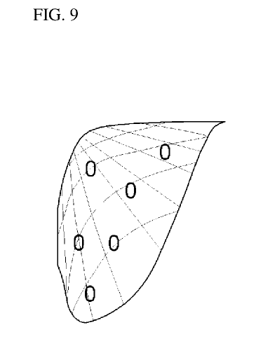

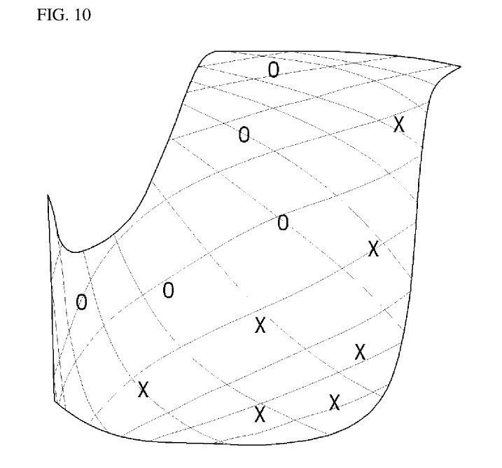

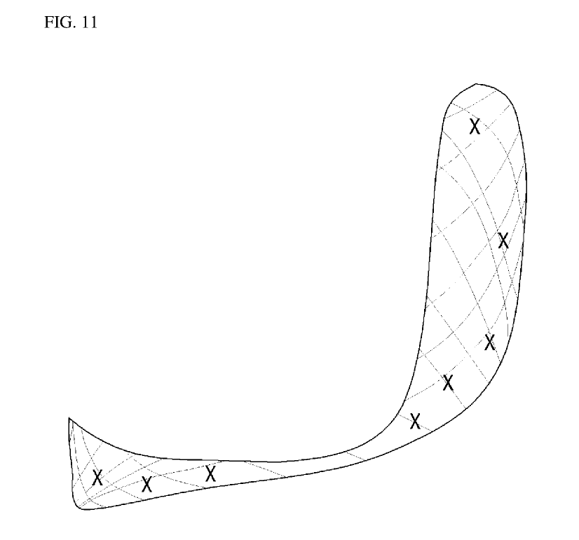

Until now, the configuration and typical operation of the digital circuit error verification apparatus 100 according to the embodiment have been described. Hereinafter, a method of verifying an error in a digital circuit using the digital circuit error verification apparatus 100 according to an embodiment will be described with reference to FIGS. 2 through 13.

FIG. 2 is a flowchart illustrating a method of verifying an error in a digital circuit according to an embodiment. This method is merely an embodiment for achieving the objectives of the inventive concept, and some operations can be added or deleted as needed.

Referring to FIG. 2, the digital circuit error verification apparatus 100 generates a first attribute value using metadata of a first digital circuit diagram, mechanically decomposes a digital circuit indicated by the first digital circuit diagram into individual elements, generates a second attribute value using the result of mechanical decomposition, and generates an attribute database including the generated first attribute value and second attribute value (operation S210).

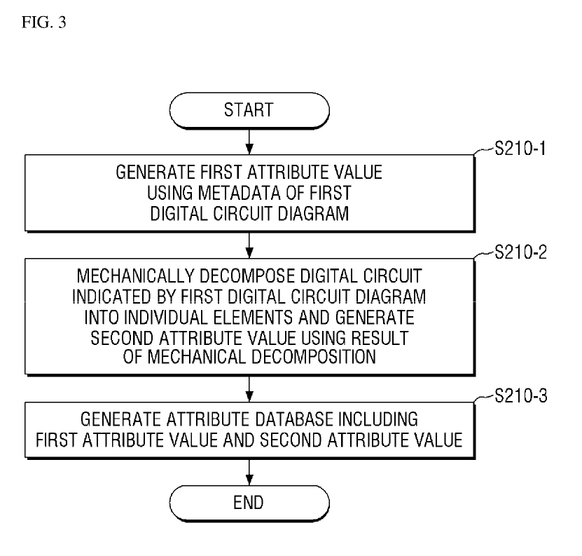

Here, operation S210 can be broadly divided into three operations: generation of the first attribute value, generation of the second attribute value, and generation of the attribute database 15. Operation S210 will be described with reference to FIG. 3.

FIG. 3 is a flowchart illustrating a method of verifying an error in a digital circuit according to an embodiment, more specifically, operation S210. This method is merely an embodiment for achieving the objectives of the inventive concept, and some operations can be added or deleted as needed.

Referring to FIG. 3, the digital circuit error verification apparatus 100, more specifically, the attribute generation module 10 receives a first digital circuit diagram and generates a first attribute value using metadata of the first digital circuit diagram (operation S210-1).

Since the first digital circuit diagram can be a file in various formats, the attribute generation module 10 should have a program compatible with the file format of the first digital circuit diagram.

In addition, the first digital circuit diagram may be input by, for example, directly injecting the first digital circuit diagram into the digital circuit error verification apparatus 100 or downloading the first digital circuit diagram that is distributed or stored online. That is, there is no limitation on the method of inputting the first digital circuit diagram.

The metadata of the first digital circuit diagram may include various items. For example, the metadata may include one or more of a circuit diagram of a first digital circuit, a product group to which the first digital circuit belongs, the result (pass/fail) of simulating the first digital circuit, and a defect rate generated in the process of producing the first digital circuit. In addition, the metadata may include an item such as specifications of the digital circuit. That is, the metadata of the first digital circuit diagram is not limited to a particular type.

The first attribute value generated using the metadata of the first digital circuit diagram is basically the same as or similar to the content of the metadata of the first digital circuit diagram. For example, when the first digital circuit diagram has the simulation result (pass/fail) of the first digital circuit as the metadata, the attribute generation module 10 may read the simulation result and generate the simulation result (pass/fail) of the first digital circuit as the first attribute value. That is, since the term “using” in the above includes the meaning of analysis, even if the first attribute value and the metadata of the first digital circuit diagram have the same content, the first attribute value is generated by reading the metadata of the first digital circuit diagram.

The attribute generation module 10 may generate the first attribute value for all items included in the metadata of the first digital circuit diagram. The first attribute value may be used to generate a pattern and analyze a second digital circuit diagram in the operation of machine learning such as supervised learning and reinforcement learning. Therefore, as more various first attribute values are generated, the pattern generation and the analysis of the second digital circuit diagram can be performed in more various ways.

Next, the digital circuit error verification apparatus 100, more specifically, the attribute generation module 10 mechanically decomposes a digital circuit (hereinafter, referred to as a first digital circuit) indicated by the first digital circuit diagram into individual elements and generates a second attribute value using the result of mechanical decomposition (operation S210-2).

Here, the mechanical decomposition may be performed according to a predetermined rule. Mechanically decomposing the digital circuit indicated by the first digital circuit diagram into the individual elements is merely an embodiment of mechanical decomposition performed according to a predetermined rule. Therefore, various digital circuit decomposition methods can be used.

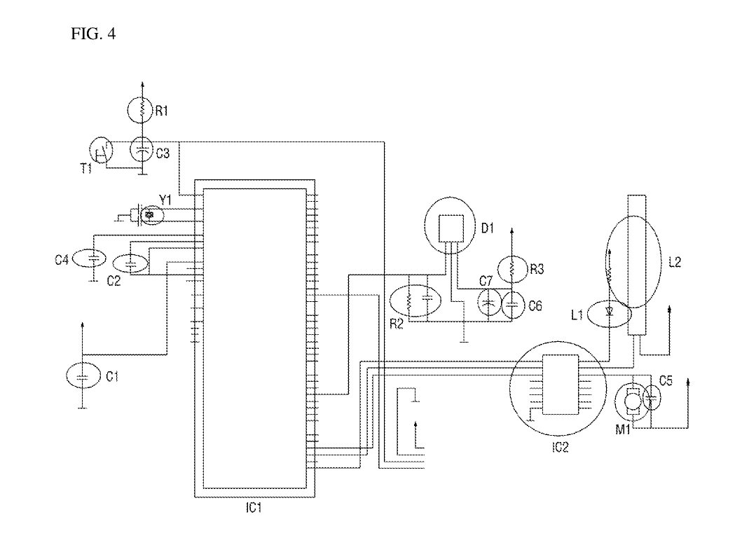

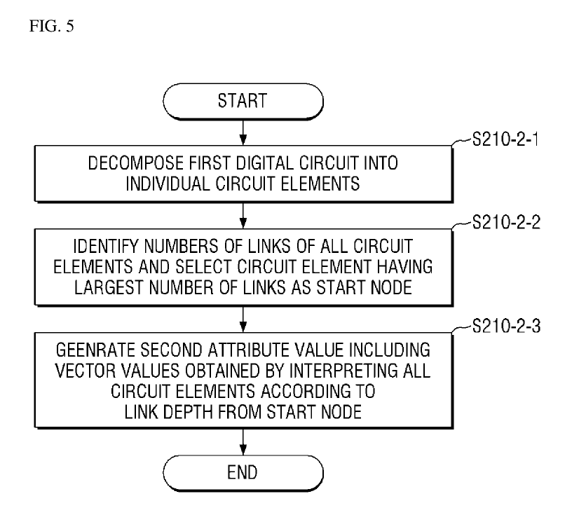

FIG. 4 illustrates a first digital circuit, and FIG. 5 is a flowchart illustrating a method of mechanically decomposing a first digital circuit into individual elements.

Referring to FIG. 5, a first digital circuit is decomposed into individual circuit elements (operation S210-2-1).

In FIG. 4, all circuit elements included in the first digital circuit are represented by quadrilaterals or circles. In the element-based decomposition, elements playing the same role are also separated from each other. For example, a plurality of resistors R1 through R3 are separated from each other, and a plurality of capacitors C1 through C4 are separated from each other as illustrated in FIG. 4.

Next, the numbers of links of all of the circuit elements are identified to select a circuit element having a largest number of links as a start node (operation S210-2-2).

Here, a link refers to the number of connections of one element to other elements. Referring to FIG. 4, an IC1 element has the largest number of links. Therefore, the IC1 element may be selected as a start node. Since an element having the largest number of links can be considered as a most widely used element, it may best reflect characteristics of the first digital circuit. Therefore, the element having the largest number of links can improve the reliability of the result of machine learning such as supervised learning and reinforcement learning which will be described later. However, this is merely an embodiment for generating vector values necessary for machine learning, and the start node can also be selected regardless of the number of links or using a completely different method. For example, the start node may be selected by assigning a weight according to the type of an element, instead of the number of links. Specifically, a larger weight may be assigned to core elements such as integrated circuits and chips than to elements such as resistors and capacitors. This method is very useful when the start node is selected from core elements having the same number of links, for example, when any one of an integrated circuit and a chip having the same number of links has to be selected as the start node. For example, if a weight of 1.4 is assigned to an integrated circuit having six links and a weight of 1.1 is assigned to a chip having six links, the integrated circuit may have 8.4, and the chip may have 6.6. Therefore, the integrated circuit may be selected as the start node.

Once the start node is selected, a second attribute value including vector values obtained by interpreting all of the circuit elements according to a link depth from the start node is generated (operation S210-2-3). Here, the link depth indicates whether another element is linked between two elements (direct link). For example, in FIG. 4, since no element is linked between IC1 and C1, the link depth is 1. On the other hand, since IC2 is linked between IC1 and L1, the link depth is 2.

The link depth can be freely adjusted according to whether the start node is directly linked to all of the circuit elements. For example, the second attribute value may be generated by setting the link depth to 1 or by setting the link depth to 2. Alternatively, the second attribute value may be generated for both a link depth of 1 and a link depth of 2. In other words, generating the second attribute value may be determined according to the circuit configuration of the first digital circuit.

Referring again to FIG. 4, vector values that can be generated for a link depth of 1 are as follows. When the start node is IC1, elements having a link depth of 1 are C1, C2, C3, C4, D1, R1 R2, Y1 T1, and IC2. In this case, vectors such as ICI C1, IC1→C2, IC1→C3, IC1→C4, IC1→D1, IC1→R1, IC1→R2, IC1→Y1, IC1→T1, and IC1→IC2 are generated. However, these ten vectors cannot represent the relationships between all elements included in the first digital circuit. In addition, since there are elements having a link depth of 2 in FIG. 4, vectors for these elements should be generated.

When the start node is IC1, elements having a link depth of 2 are L1, L2, M1, C5, C6, C7, and R3. In this case, vectors such as IC1→IC2→L1, IC1→IC2→L2, IC1→IC2→M1, IC1→IC2→C5, IC1→D1→C6, IC1→D1→C7, and IC1→D1→R3 are generated.

Therefore, all vectors generated are IC1→C1, IC1→C2, IC1→C3, IC1→C4, IC1→D1, IC1→R1, IC1→R2, IC1→Y1, IC1→T1, IC1→IC2, IC1→IC2→L1, IC1→IC2→L2, IC1→IC2→M1, IC1→IC2→C5, IC1→D1→C6, IC1→D1→C7, and IC1→D1→R3. These vectors are generated as the second attribute value, and the second attribute value corresponds to vector values that can represent the relationships between all elements included in the first digital circuit.

The second attribute value including vector values can also be generated without adjusting the link depth. In an embodiment, even when the link depth is fixed to 1, the relationships between all elements included in the first digital circuit can be generated as vectors. In this case, a branch node connected to the start node with a link depth of 1 may be selected as another start node for vector generation. For example, FIG. 4, when the start node is IC1, elements having a link depth of 1 are C1, C2, C3, C4, D1, R1, R2, Y1, T1, and IC2. In this case, vectors such as IC1→C1, IC1→C2, IC1→C3, IC1→C4, IC1→D1, IC1→R1, IC1→R2, IC1→Y1, IC1→T1, and IC1→IC2 are generated as described above. However, of the C1, C2, C3, C4, D1, R1, R2, Y1, T1 and IC2, some elements are no longer linked to other elements, and some elements are linked to other elements. Here, the elements linked to other elements may be selected as start nodes. That is, D1 and IC2 may be selected as start nodes. In this ease, elements linked to D1 and IC2 with a link depth of 1 are R3, C6 and C7 and L1, L2, M1 and CS, respectively. Therefore, D1→R3, D1→C6 and D1→C7 vectors are generated based on D1, and IC2→L1, IC2→L2, IC2→M1 and IC2→C5 vectors are generated based on IC2. Since D1 can be represented by IC1→D1 and IC2 can be represented by IC1→IC2, if D1 and IC2 are substituted with IC1→D1 and IC1→IC2, respectively, IC1→D1→R3, IC1→D1→C6, IC1→D1→C7, IC1→IC2→L1, IC1→IC2→L2, IC1→IC2→M1, and IC1→IC2→C5 vectors are generated. Ultimately, all vectors generated are IC1→C1, IC1→C2, IC1→C3, IC1→C4, IC1→D1, IC1→R1, IC1→R2, IC1→Y1, IC1→T1, IC1→IC1→IC2, IC1→D1→R3, IC1→D1→C6, IC1→D1→C7, IC1→IC2→L1, IC1→IC2→L2, IC1→IC2→M1, and IC1→IC2→C5, which are the same as those generated by adjusting the link depth. That is, the same second attribute value including generated vector values is generated when the link depth is adjusted and when the link depth is not adjusted, and only the process of generating the second attribute value is partially different depending on the interpretation method and the link depth.

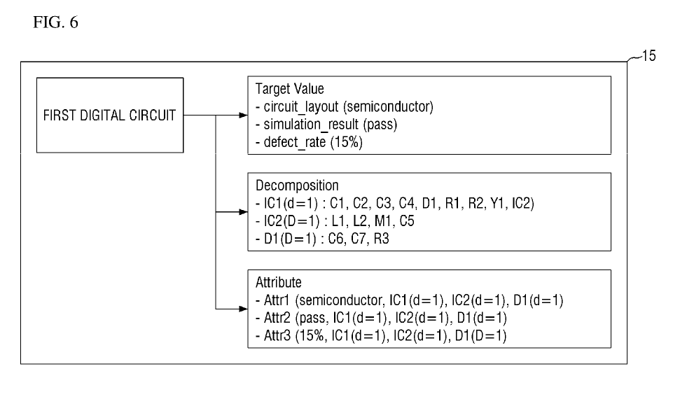

After the second attribute value is generated, the attribute database 15 including the first attribute value and the second attribute value is generated (operation S210-3). An example of the attribute database 15 generated for the first digital circuit can be found in FIG. 6.

Returning to FIG. 2, after the generation of the attribute database 15, the digital circuit error verification apparatus 100 performs supervised learning by using the attribute database 15 to generate a pattern according to a verification purpose and generates the pattern database 25 including the generated pattern (operation S220).

Here, the pattern is the same as that described above in relation to the digital circuit error verification apparatus 100. That is, if the verification purpose is a product group of a digital circuit, a simulation result, or a defect rate at the production stage, the pattern database 25 including a pattern about a digital circuit product group, a pass/fail pattern based on a simulation result, or a pattern based on a defect rate at the production stage is generated. More specifically, for example, if the first digital circuit of FIG. 4 is a semiconductor, supervised learning may be performed on a first attribute and a second attribute for a semiconductor product group, and the pattern database 25 including a pattern about the semiconductor product group may be generated. In addition, if the simulation result of the first digital circuit of FIG. 4 is “pass,” supervised learning may be performed on the first attribute and the second attribute for the simulation result of pass, and the pattern database 25 including a pattern about the simulation result of pass may be generated. If the defect rate of the first digital circuit at the production stage is 15%, supervised learning may be performed on the first attribute and the second attribute for the defect rate of 15%, and the pattern database 25 including a pattern about the defect rate of 15% may be generated.

Since the above description is based on the, first digital circuit, only a pattern generated through supervised. learning on the first digital circuit is stored in the pattern database 25. However, since the effect of supervised learning increases as the supervised learning is repeated, attributes of first to N^{th} digital circuits (N is a positive integer) are accumulated in the attribute database 15. As supervised learning is performed on these attributes, more various patterns are accumulated in the pattern database 25, thereby increasing the reliability of the result of verifying a digital circuit.

After the pattern database 25 is generated, the digital circuit error verification apparatus 100 generates a third attribute value and a fourth attribute value by analyzing a second digital circuit diagram, which is a target of error verification, in the same way as the first digital circuit diagram, generates verification request data including the third attribute value and the fourth attribute value, selects a comparison target pattern from the pattern database 25 according to a verification purpose, and verifies an error in the second digital circuit diagram by comparing the selected comparison target pattern with the verification request data (operation S230).

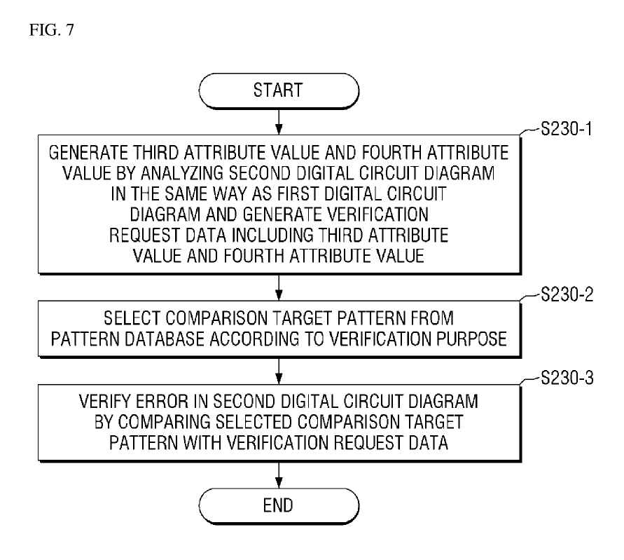

Here, operation S230 can be broadly divided into three operations: generation of the verification request data, selection of the comparison target pattern, and error verification of the second digital circuit diagram. Operation S230 will be described with reference to FIG. 7.

FIG. 7 is a flowchart illustrating a method of verifying an error in a digital circuit according to an embodiment, more specifically, operation S230. This method is merely an embodiment for achieving the objectives of the inventive concept, and some operations can be added or deleted as needed.

Referring to FIG. 7, the digital circuit error verification apparatus 100, more specifically, the attribute generation module 10 generates a third attribute value and a fourth attribute value by analyzing a second digital circuit diagram, which is a target of error verification, in the same way as the first digital circuit diagram and generates verification request data including the third attribute value and the fourth attribute value (operation S230-1).

Here, since the second digital circuit diagram is analyzed by the attribute generation module 10 in the same way as in operation S210, the verification request data including the third attribute value and the fourth attribute value is in the same format as the first attribute, value and the second attribute value. A specific analysis method will not be described here to avoid redundancy.

After the verification request data is generated, the digital circuit error verification apparatus 100, more specifically, the circuit verification module 30 selects a comparison target pattern from the pattern database 25 according to a verification purpose (operation S230-2). Here, the verification purpose is the same as that described above. For example, if the verification purpose is a product group of a digital circuit, a simulation result, or a defect rate at the production stage, a pattern selected from the pattern database 25 may be a pattern about a digital circuit product group, a pass/fail pattern based on a simulation result, or a pattern based on a defect rate at the production stage. More specifically, for example, if the second digital circuit is a semiconductor, a pattern about a semiconductor product group generated as a result of supervised learning may be selected from the pattern database 25. If the simulation result of the second digital circuit is “pass,” a pattern about the simulation result of pass generated as a result of supervised learning may be selected from the pattern database 25. In addition, if the defect rate of the second digital circuit at the production stage is 15%, a pattern about the defect rate of 15% generated as a result of supervised learning may be selected from the pattern database 25.

Next, an error in the second digital circuit diagram is verified by comparing the selected comparison pattern with the verification request data (operation S230-3)

Here, the verification of the error and the result of error verification may be output in the form of a multidimensional graph after reinforcement learning is performed. This will now be described in detail.

After verifying the error in the second digital circuit diagram, the digital circuit error verification apparatus 100 performs reinforcement learning to reflect the result of error verification in the pattern database 25 (operation S240).

Through the reinforcement learning on the result of error verification, a large amount of data about error verification may be accumulated in the pattern database 25. As a result, the reliability of the result of machine learning can be improved.

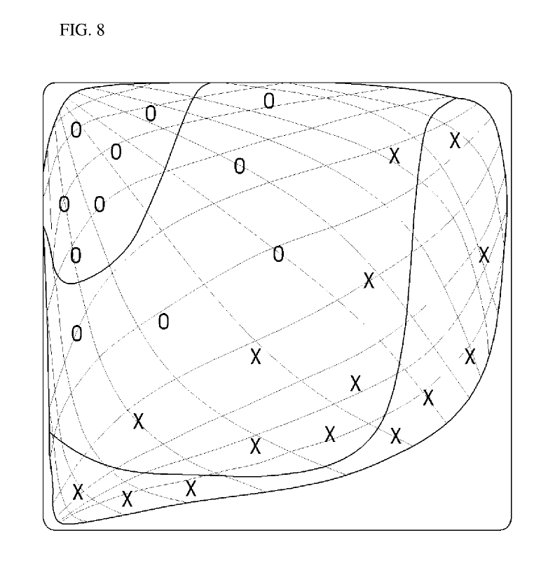

Next, the pattern database 25 outputs the result of supervised learning and reinforcement learning in the form of a multidimensional graph according to linear fitting and nonlinear transformation (operation S250). As can be seen in FIG. 8, the pattern database 25 may determine sections, based on which a verification result value can be judged, according to linear fitting and nonlinear transformation. For example, a normal section, a moderate section, and an abnormal section may be determined as illustrated in FIGS. 8 and 9 through 11. In some cases, however, it may be difficult to determine accurate sections. In such cases, the pattern database 25 may determine sections based on a large amount of data accumulated repeatedly and then gradually correct the sections.

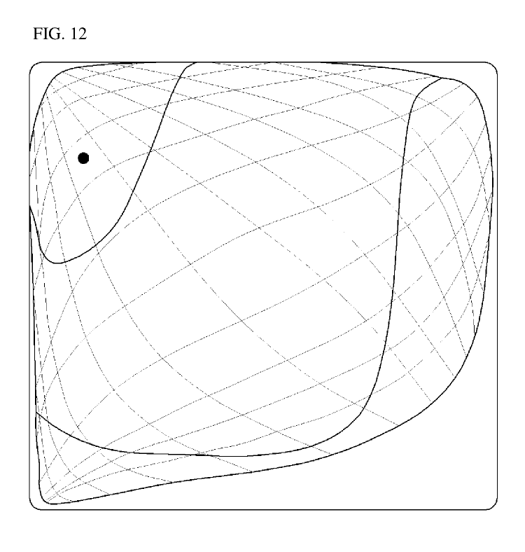

In addition, the result of error verification performed in operation S230-3 may be displayed as coordinates in any one of the normal section, the moderate section, and the abnormal section of the multidimensional graph. This can be found in FIG. 12.

For example, if the result of error verification is displayed in the normal section as illustrated in FIG. 12, it can be understood that no error has occurred in the second digital circuit diagram. If the result of error verification is displayed in the abnormal section, it can be understood that an error has occurred in the second digital circuit diagram. However, if the result of error verification is displayed in the moderate section, it may be difficult to judge whether an error has occurred in the second digital circuit diagram. In this case, the probability of error occurrence may be calculated as follows.

First, lengths of shortest perpendicular lines extending from coordinates of the result of error verification displayed in the moderate section to the normal section and the abnormal section are calculated. Then, a ratio of the length of each perpendicular line to the sum of the calculated lengths of the perpendicular lines is calculated to output probabilities that the second digital circuit diagram will be normal and abnormal.

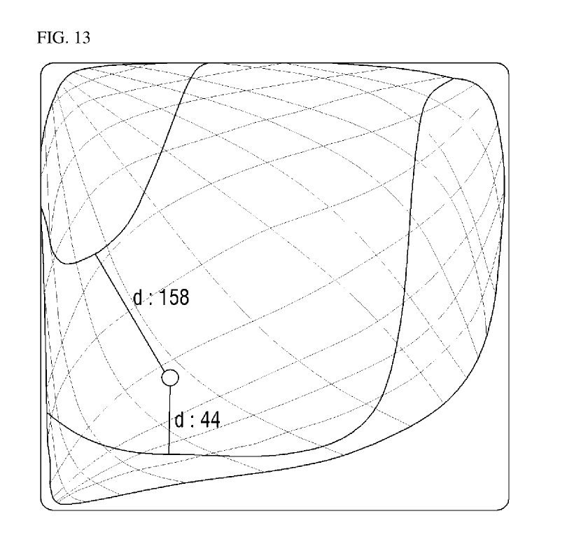

Referring to FIG. 13, the length of the shortest perpendicular line extending from the coordinates of the result of error verification displayed in the moderate section to the normal section is 158, and the length of the shortest perpendicular line extending from the coordinates of the result of error verification displayed in the moderate section to the abnormal section is 44. Therefore, the sum of the lengths of the two perpendicular lines is 202. If the ratio of the length of each perpendicular line to the sum of the lengths of the two perpendicular lines is calculated, the probability that the second digital circuit diagram will be normal is (202-158)/202=21.8%, and the probability that the second digital circuit diagram will be abnormal is (202-44)/202=78.2%. In this case, it can be understood that the second digital circuit diagram is highly likely to have an error.

What has been described so far is about the process of accumulating data about a first digital circuit diagram in the attribute database 15, additionally accumulating data about a second digital circuit diagram which is a target of error verification, and verifying an error by performing supervised learning and reinforcement learning. Therefore, since the supervised learning and the reinforcement learning are performed only once, the reliability of the result of error verification may not be considered high. However, by the time when the error verification is performed on up to an Nth digital circuit diagram, sufficient supervised learning and reinforcement learning will have been performed. Therefore, the reliability of the result of error verification will be higher than that of the result of error verification by any other digital circuit error verification system.

According to the inventive concept, the reliability of the verification result of a digital circuit can be improved even in the absence of a pre-created template.

In addition, as error verification of digital circuits is repeated, a large amount of data is automatically accumulated, and supervised learning and reinforcement learning are performed on the data. Therefore, the reliability of the verification results of subsequent digital circuits can be gradually increased.

Furthermore, an error that may occur in the actual production process can be accurately predicted based on a pattern according to a verification purpose.

However, the effects of the inventive concept are not restricted to the one set forth herein. The above and other effects of the inventive concept will become more apparent to one of daily skill in the art to which the inventive concept pertains by referencing the claims.

What is claimed is:

1. A method of verifying an error in a digital circuit, the method comprising:
generating a first attribute value using metadata of a first digital circuit diagram;
decomposing a digital circuit indicated by the first digital circuit diagram into individual elements;
generating a second attribute value using a result of the decomposing;
generating an attribute database comprising the first attribute value and the second attribute value using a digital circuit error verification apparatus;
performing supervised learning using the attribute database to generate a pattern according to a verification purpose and generating a pattern database comprising the generated pattern using the digital circuit error verification apparatus; and
generating a third attribute value and a fourth attribute value by analyzing a second digital circuit diagram, which is a target of error verification;
generating verification request data comprising the third attribute value and the fourth attribute value;
selecting a comparison target pattern from the pattern database according to the verification purpose; and
verifying an error in the second digital circuit diagram by comparing the selected comparison target pattern and the verification request data using the digital circuit error verification apparatus.

2. The method of claim 1, wherein the metadata of the first digital circuit diagram comprises at least one of a product group to which the first digital circuit belongs, a simulation result, and a defect rate in a production process.

3. The method of claim 1, wherein the digital circuit error verification apparatus generates the second attribute value by decomposing the digital circuit indicated by the first digital circuit diagram into the individual elements according to a predetermined rule, wherein the predetermined rule comprises:
decomposing the digital circuit indicated by the first digital circuit diagram into the individual elements;
identifying a number of links for each individual element of the individual elements;
selecting an individual element from among the individual elements as a start node, the selected individual element having a largest number of links; and
generating the second attribute value, which comprises vector values obtained by interpreting the individual elements according to a link depth from the start node.

4. The method of claim 3, wherein the link depth is adjustable according to whether the start node is directly linked to all of the individual elements.

5. The method of claim 1, further comprising performing reinforcement learning corresponding to a result of error verification in the pattern database after the verifying of the error using the digital circuit error verification apparatus.

6. The method of claim 5, wherein the pattern database outputs the result of the supervised learning and the reinforcement learning as a multidimensional graph according to linear fitting and nonlinear transformation.

7. The method of claim 6, wherein the multidimensional graph is divided into a normal section, a moderate section, and an abnormal section.

8. The method of claim 7, wherein the verifying of the error comprises displaying the result of the error verification as coordinates in one of the normal section, the moderate section and the abnormal section of the multidimensional graph using the digital circuit error verification apparatus.

9. The method of claim 8, wherein in response to the coordinates being displayed in the moderate section of the multidimensional graph, the method further comprises:
calculating a first length of a shortest perpendicular line from the coordinates to the normal section, and a second length of a shortest perpendicular line from the coordinates to the abnormal section;
calculating a ratio of the first length to a sum of the first length and the second length, and a ratio of the second length to the sum of the first length and the second length; and
outputting a probability that the second digital circuit diagram is normal and a probability that the second digital circuit diagram is abnormal using the digital circuit error verification apparatus.
